(19) United States
(12) Patent Application Publication
(10) Pub. No.: US 2011/0018272 A1
(43) Pub. Date: Jan. 27, 2011

(54) Direct driven free flow turbine

(76) Inventor: Kalman N. Lehoczky, Palmetto, FL (US)

Correspondence Address: Kalman N. Lehoczky, 4411 16th Ave. East, Palmetto, FL, 34221, US

(21) Appl. No.: 12/313,100

(22) Filed: Nov. 18, 2008

(51) Int. Cl. H02K 7/18; F03B 13/10

(52) U.S. Cl. 290/52

(57) ABSTRACT

Hydraulic turbine immerged into a free flowing current consisting of a turbine runner that drives an electrical generator in direct shaft connection without rotational speed increasing transmission and the electric generator's stator bore diameter is smaller than the stator core length.

### A. BACKGROUND OF THE INVENTION

1. Field of Invention

This invention relates to turbines submerged in free flowing water current utilizing the kinetic energy of free flowing water. These turbines are usually called Free Flow Turbines.

2. Description of the Prior Art

The conventional free flow turbine runner is connected to the electric generator through a speed increasing transmission. The assembly consisting of the turbine runner, turbine shaft, transmission and generator rotor is frequently called the drive train. The purpose of the speed increasing transmission is to increase the generator's rotational speed in relation to the turbine runner's slow rotational speed. The reason is that size of the electric generator is inversely related to the rotational speed. A doubling of the rotational speed approximately reduces the volume of the generator rotor to the half. Usually the speed increase is much higher than one to two. The reduced generator size permits use of a housing also called nacelle with smaller cross-section and improved flow condition with respect to the turbine. Typically, a conventional low speed and high volume hydro generator has a stator bore diameter that is several times larger than the stator core length thus the generator's cross-section area perpendicular to the rotational axis is huge. Application of a large diameter hydro-generator in a free flow turbine would require a large nacelle causing unacceptable disturbance of the flow through the turbine runner with a consequent huge reduction of the hydrodynamic efficiency. Therefore, the speed increasing transmission with radical reduction of the generator's volume and cross-section seems to be highly attractive. In spite of the obvious benefit a speed increasing transmission it has significant disadvantages. The greatest disadvantage is that transmissions cannot be built without internal wear and without an inevitable limitation of life-expectancy. Most transmissions demand a regular maintenance routine with change of lubricants, filters and other parts as well as general condition assessment. In case of free flow turbines submerged in free flowing rivers and ocean currents the maintenance and repair operations are extremely difficult and expensive. Delaying or reducing the frequency of these maintenance activities operations may lead to disastrous damages.

The objective of this invention is to avoid the above disadvantages and shortcomings by designing a drive train without the problems caused by the speed increasing transmission.

### B. SUMMARY OF INVENTION

Briefly stated, in accordance with one aspect of the present invention free flow turbine submerged in free flowing current contains a drive train having direct shaft connection between turbine runner and generator and the generator having stator bore diameter that is smaller than the stator core's axial length.

Other features of the invention will be described in connection with the drawing.

### C. DESCRIPTION OF THE DRAWING

FIG. 1 shows a longitudinal cross-section of a free flow turbine in accordance with the present invention.

The turbine runner's hub 1 carrying the turbine blades 2 is installed on the end of the turbine shaft 3. The hub is secured on the turbine shaft using axial bolts 4. The turbine shaft enters into the turbine housing also called nacelle 9 through a shaft seal system 5 separating the water in the external current 6 from the internal space 7 enveloped by the turbine housing. The turbine housing consists of three major sections; the tapered tail section 9, the central generator section 10 and the frontal bulb section 17. The hub may be equipped with a streamlining cap 18 bolted 19 to the hub 1 but this rotating cap may not be regarded as a part of the housing. The turbine bearing 8 supports the shaft 3 carrying the vertical load originated in the turbine runner and the shaft weight. The turbine shaft 3 is long because the housing must have a relatively long tapered section 9 ensuring a smooth converging flow 6 of the external current arriving from the wider generator 10 section to the turbine hub 1 that may have a much smaller diameter. Another reason is that the stable transversal positioning of the turbine runner may require a certain distance between the turbine bearing 8 and the drive side generator journal bearing 11.

The generator rotor contains a central rim section 12 that is similar to a tube with coupling flanges 13 and 14 on “drive” also called “DS” and the “non-drive” also called “NS” axial ends. The large diameter flange 15 of the turbine shaft 3 is directly bolted 16 to the central rim section 12.

The rotor's non-drive NS flange 14 is bolted 16 to large diameter flange 20 of the stubshaft 21 supported by the non-drive end, NS, generator journal bearing 22. The turbine shaft 3 together with the central rim section 12 and the stubshaft 21 creates a single rigid shaft unit that is hollow 23 in the central rim section 12 and supported by the generator journal bearings 11 and 22. A structure like this has a large transversal bending rigidity in relation to its weight. This is important with respect to the possible transversal magnetic pull between the stator and rotor as well as from the point of view of avoiding conflict between the shaft's natural frequencies and the turbine's rotational peed.

In accordance with this invention the stator core 24 and stator winding 25 can be enclosed in a secluded stator space 26 separated from the other spaces 7 contained by the turbine housing 9, 10 and 17. The secluded stator space 26 is defined in shown execution example by the generator housing 10, the stator end ring 28 and air gap cylinder 27. Since the air gap cylinder is exposed to an alternating magnetic field, therefore, it should be made of non-ferromagnetic material such as stainless steel or similar. The secluded stator space 26 is recommended to be filled with a medium that is electric insulating, non-corrosive and harmless for the non-metallic insulation materials used in the stator winding 25 and core 24.

In accordance with this invention the space surrounding the rotating system is filled with a liquid, for example water, thus the air gap in the generator 29 between the generator rotor and the air gap cylinder 27 is filled with this liquid.

The rotor system is equipped with hydrodynamic axial thrust bearings 30 and 31 able to carry the axial load originated in the turbine runner and in other parts of the rotating system.

In accordance with this invention both the journal bearings, 8, 11, 22 and the axial thrust bearings 30, 31 are lubricated by the same fluid that surrounds the generator rotor.

Water lubricated bearings are well known in the hydraulic turbine building and the detail design of the above journal and thrust bearings does not represent any limitation for this invention.

In accordance with this invention the fluid surrounding the rotor and used also for lubrication of the bearings is taken from the water current 6 surrounding the free flow turbine. Since the current may contain floating sand and a variety of debris, therefore, the water is taken from a location with the lowest probability of suspended materials, transported through strainer prior to being pumped into the internal spaces of the unit. For example, the water may be taken from the inside of the hollow structure 32 supporting the free flow turbine unit, through a strainer 33 and pipe line 34 to a pump 37 inside the bulb housing 17. The end surface of the stub shaft 21 has an axially waved surface 36. A rolling contact on the waved surface may activate a displacement pump 37, for example a membrane pump, pumping the water into the internal spaces, 7, including the air gap 29.

In accordance with the present invention the pressure achieved by the pump 37 is higher than the pressure in the free flowing current 6. Therefore, the water leakage through the shaft seal system 5 is always outward oriented, thus no unfiltered water can enter through the shaft seal 5 into the internal spaces of the free flow turbine.

The outer surface of the rotor rim 12 may be equipped with poles 38 or slots as usual in synchronous and asynchronous generators. The preferred configuration is the synchronous generator type rotor where the poles, also called field-poles 38 create the magnetic field that penetrates also the stator core 24 and induces an alternating voltage and current in the stator winding 25. The simplest field pole arrangement is where the magnetic field is created by permanent magnets. However, the permanent magnets cannot be regulated to induce a certain voltage in the stator winding 25. Therefore, instead of or in addition to the permanent magnets also field coils can be installed on the rotor poles carrying regulated field current.

Typically, the field current is introduced to the rotor of synchronous generators through electric sliding contacts consisting of rotating collector rings and stationary brushes. This is not a possible solution in the present case since a fluid for example water surrounds the rotor. Another known method is the so-called brushless excitation system.

The brushless excitation system is based on a small synchronous machine, also called excitation machine having a rotor on common shaft with the main synchronous generator. The excitation machine is a reversed synchronous machine since it has a stationary field winding in the stator and a multiphase armature winding in the rotor. The excitation machine's stator receives a regulated direct current from an outside source while a multiphase alternating current is induced in the rotor's armature winding. The excitation machine's rotor is equipped with a rotating converter consisting of diodes or thyristors transforming the alternating current into direct current. This direct current is used as field current in the rotor of the main synchronous generator. Since the rotor of the brushless excitation machine and the converter is on common shaft with the main synchronous generator, therefore, the direct current produced by the rotating converter can be directly introduced to the field winding of the main synchronous machine without sliding contacts. By regulating the field current in the brushless exciter's stator also the field current in the main machine will be regulated as the actual operational condition requires. Theoretically, a such brushless excitation system would be applicable in a free flow turbine with water in the rotor's surrounding. However, the low rotational speed would cause the dimensions of the brushless excitation machine to become excessive.

In accordance with the present invention a rotating transformer will supply the alternating current to the rotating converter that will produce the main machine's field current. A rotating transformer has primary windings in the stator and secondary winding in the rotor. Both of these windings are carrying alternating current as in a transformer. Similarly to a stationary transformer also in a rotating transformer uses an alternating magnetic field to transfer the energy from the primary to the secondary winding thus not the relative motion of a conductor through the magnetic field but the alternating magnetic field generates the current in the secondary winding. Consequently, the energy transfer in a rotating transformer occurs even when both the primary and secondary windings are stationary. In connection with the main generator it was discussed that the size and volume of the generator inversely related to the rotational speed. This is not valid for a rotating transformer because the energy transfer from the stationary coils to the rotating coils is based on an alternating magnetic field and not by the relative movement between a magnetic field and a coil.

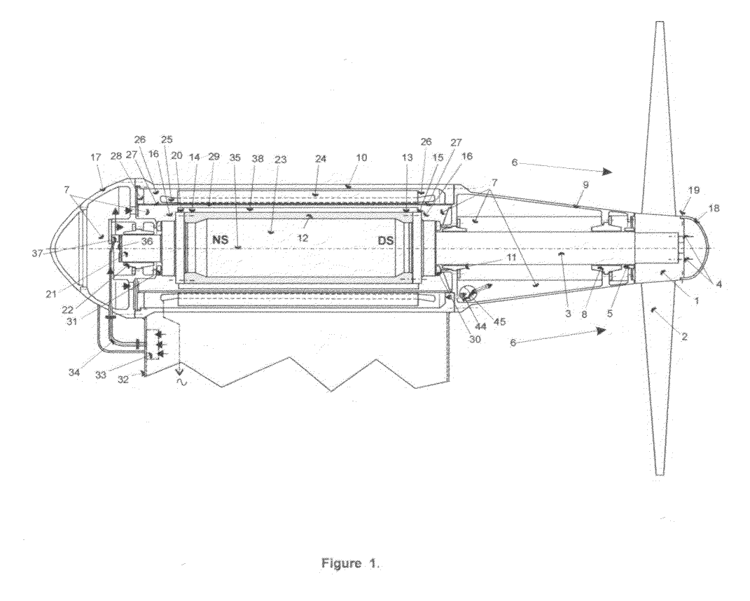

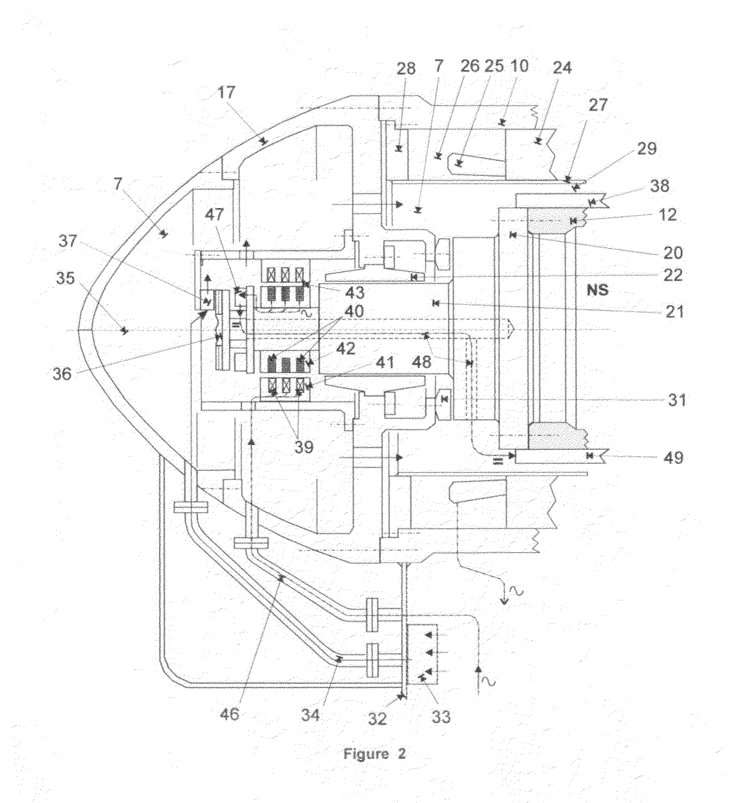

FIG. 2 shows the general arrangement. In relation to FIG. 1 the change will relate mainly to the NS side of the generator.

The rotating transformer consists of a set of ring shaped stationary primary coils 39 surrounding the rotational axis 35 and another set of ring shaped rotating secondary coils 40 surrounding the rotational axis 35. Thus the stationary primary coils 39 and secondary coils 40 are concentrically arranged in relation to each other with a common center in the rotational axis 35. The application example in FIG. 2 shows three primary coils 39 and three secondary coils 40 as typical in a three-phase transformer. Solutions based on other phase numbers are covered by this invention. In order to ensure a strong magnetic field connection between the primary and secondary coils 39 and 40 laminated stationary core 41 and rotating core 42 surrounds the coils 39 and 40. Consequently the magnetic field circuit's only interruption only is at the air gaps 43 separating the stationary core 41 and rotating core 42. In the shown application example with three-phase transformer there are four axi-symmetrical air gaps 43 surrounding the rotational axis 35.

The rotating transformer can be submerged into and cooled by the same media that files the spaces 7 around the main generator's rotor or by an insulating media for example similar to that 26 used around the stator winding and core. In accordance with this invention the complete rotor of the rotating transformer is insulated through a vacuum impregnating process and or immerged in a cast such as epoxy. The same process can be used for the complete stator of the rotating transformer. Of course the stator and rotor will be independent units separated by the air gap 43. The above procedure makes the immersion of the rotating transformer into a liquid cooling medium highly practical.

The rotating exciter may receive a regulated primary alternating current through a cable 46. The secondary alternating current from the rotating transformer's secondary coils is introduced to the rotating converter 47 installed on the shaft 21. After conversion from alternating into direct current that will be used as the field current in the main generator. The field, also called excitation current, shall be conducted through another cable 48, also in the rotating system, to the main generator's field coils 49. The field coils may be applied in addition to the permanent magnet rotor poles 38.

In accordance with this invention rooms, for example around the stator winding 26 filled with special media different from that used in spaces 7 around the rotor are equipped with heat expansion devices 44 with movable or flexible walls 45 separating the special media from that used in the room 7. The movable or flexible wall 45 permits an heat expansion or contraction of the special media without mixing it with the media in the other spaces 7. The location or number of the heat expansion devices is not limiting the validity of the present invention.

What is claimed is:

1. Free flow turbine submerged in free flowing current contains a drive train having direct shaft connection between turbine runner and generator rotor and the generator having stator bore diameter that is smaller than the stator core's axial length.

2. Free flow turbine in accordance with claim 1 characterized by a generator rotor having permanent magnet field poles.

3. Free flow turbine in accordance with claim 1 characterized by a generator rotor having field coils energized from a rotating transformer build on common shaft with the main generator.

4. Free flow turbine in accordance with claim 1 characterized by having room around the rotating system filled with the same fluid that is in the free flowing current.

5. Free flow turbine in accordance with claim 1 characterized by having a pump creating a higher pressure in the turbine housing than that in the surrounding free flowing current.

6. Free flow turbine in accordance with claim 1 characterized by having bearings lubricated by the same fluid that is in the free flowing current.

7. Free flow turbine in accordance with claim 1 characterized by being having a non-magnetic air gap cylinder creating a separate space containing the stator winding and stator core and that the separate space is filled with a medium with good electric insulation capacity.
